(19) United States
(12) Patent Application Publication
(10) Pub. No.: US 2025/0124823 A1
(43) Pub. Date: Apr. 17, 2025

(54) THEFT DETERRENT LABEL AND PACKAGING INCORPORATING THE SAME

(71) Applicant: Custom Security Industries Inc., Richmond Hill (CA)

(72) Inventors: Robert Petryczka, Richmond Hill (CA); Lucien Curnew, Richmond Hill (CA); Peter Murdoch, Richmond Hill (CA); Morton Roseman, Richmond Hill (CA)

(73) Assignee: Custom Security Industries Inc., Richmond Hill (CA)

(21) Appl. No.: 18/668,728

(22) Filed: May 20, 2024

Related U.S. Application Data
(63) Continuation of application No. 17/343,368, filed on Jun. 9, 2021, now abandoned.
(60) Provisional application No. 63/140,594, filed on Jan. 22, 2021.

(51) Int. Cl. G09F 3/00; E05B 73/00; G09F 3/02

(52) U.S. Cl. CPC G09F 3/0292; E05B 73/0017; G09F 2003/0222; G09F 2003/0272

(57) ABSTRACT

A theft deterrent label comprises a flexible body portion, the body portion comprising: a first destructible section; a second destructible section, the first destructible section and the second destructible section each having at least one weakness pattern provided therein; and a non-destructible section interposed between the first destructible section and the second destructible section and substantially devoid of any weakness pattern.

### CROSS-REFERENCE TO RELATED APPLICATIONS

This application is related to U.S. patent application Ser. No. 16/597,472 filed on Oct. 9, 2019, which claims the benefit of U.S. Provisional Application No. 62/743,415 filed on Oct. 9, 2018, the entire contents of which are incorporated herein by reference. The present application is a continuation of pending U.S. patent application Ser. No. 17/343,368, filed on Jun. 9, 2021, which claims the benefit of U.S. Provisional Application No. 63/140,594 filed on Jan. 22, 2021, the entire contents of which are incorporated herein by reference.

### FIELD

The subject disclosure relates to theft prevention and in particular, to a theft deterrent label and packaging incorporating the same.

### BACKGROUND

Shoplifting is a problem faced by almost all retailers. Not surprisingly therefore, antishoplifting systems such as electronic article surveillance (EAS) systems have become commonplace in retail establishments. The most commonly used EAS systems rely on Radio Frequency (RF) or Acousto-Magnetic (AM) technology. Nevertheless, all EAS systems work on the same underlying principle i.e., electronic communication between a detector that sends electromagnetic signals and anti-theft sensors which respond to the electromagnetic signals. In a typical EAS system within a retail establishment, anti-theft sensors are attached to merchandise of value and a detector is deployed at each entrance/exit of the retail establishment. When merchandise is purchased, the anti-theft sensor is either removed or deactivated at checkout from each piece of purchased merchandise allowing the purchased merchandise to pass through a detector without triggering an alarm. On the other hand, when merchandise carrying an active anti-theft sensor passes through a detector, an alarm is triggered to warn of the shoplifting attempt. While EAS systems have proven effective for the most part, shoplifters have devised clever ways to beat the technology.

In particular, in the case of EAS systems that rely on AM technology, because typical AM anti-theft sensors take the form of three-dimensional rigid packages, any appreciable bend in the packages (of more than a few degrees) may adversely affect the integrity of the AM anti-theft sensors and thus, degrade AM anti-theft sensor performance significantly. Also, typical AM anti-theft sensors have one surface with a pressure sensitive adhesive thereon to permit affixing of the AM anti-theft sensors to the merchandise to be protected. Affixing AM anti-theft sensors to merchandise in this manner does suffer drawbacks. Because the AM anti-theft sensors are exposed, an individual may insert a fingernail or suitable tool under the AM anti-theft sensors to break the adhesive bonds between the AM anti-theft sensors and the merchandise to be protected and pry the AM anti-theft sensors from the merchandise thus defeating the security feature. In the case of EAS systems that rely on RF technology, typical RF anti-theft sensors are flexible and comprise multiple layers of material and so do not suffer the bend problem associated with AM anti-theft sensors described above. That said however, like the AM anti-theft sensors, RF anti-theft sensors have an adhesive side to permit affixing of the RF anti-theft sensors to the merchandise to be protected. As a result, RF anti-theft sensors suffer drawbacks in that an individual may insert a fingernail or other suitable tool under the RF anti-theft sensors to break the adhesive bonds between the RF anti-theft sensors and the merchandise to be protected and pry the RF anti-theft sensors from the merchandise.

To make unauthorized removal of anti-theft sensors from merchandise more difficult, a sensor cover label made of destructible film and with a strong adhesive has been developed by Custom Security Industries Inc. of Richmond Hill, Ontario, Canada and sold under the name AMProtect™ for Acousto-Magnetic anti-theft sensors and RFProtect™ for Radio Frequency anti-theft sensors. The sensor cover label, with an AM/RF anti-theft sensor thereunder, is configured to be affixed to merchandise to be protected so that the AM/RF anti-theft sensor is not exposed. When the sensor cover label and AM/RF anti-theft sensor combination is properly applied to a surface of the merchandise, the edges of the sensor cover label seal tightly to the surface of the merchandise, making it difficult to peel the edges of the sensor cover label up and away from the merchandise. Also, the destructible film of the sensor cover label readily fractures when attempts are made to peel the edges of the sensor cover label. As a result, it becomes a slow and laborious task to pick the sensor cover label off the merchandise to expose the underlying AM/RF anti-theft sensor and as a result, the sensor cover label acts as a good theft deterrent.

In some situations, the anti-theft sensors are deployed on packaging containing merchandise rather than on the merchandise itself or in addition to the anti-theft sensors on the merchandise. In such cases, rather than attempting to remove the anti-theft sensors from the packaging, a shoplifter may attempt to transfer contents of packaging containing high-priced merchandise to packaging containing low-priced merchandise, thereby allowing the shoplifter to purchase high-priced merchandise (now contained in the packaging for low-priced merchandise) for the price of the low-priced merchandise. Although reinforcing tape or other suitable seals may be applied to the openings or seams of the packaging to prevent access to the interior of the packaging and the transferring of contents therein, in many cases, the tape or seals are easy to defeat.

Improvements in theft deterrence are continually being sought. It is therefore an object to provide a novel theft deterrent label and packaging incorporating the same.

This background serves only to set a scene to allow a person skilled in the art to better appreciate the following description. Therefore, none of the above discussion should necessarily be taken as an acknowledgement that this discussion is part of the state of the art or is common general knowledge.

### SUMMARY

It should be appreciated that this summary is provided to introduce a selection of concepts in a simplified form that are further described below in the detailed description. This summary is not intended to be used to limit the scope of the claimed subject matter.

Accordingly, in one aspect there is provided a theft deterrent label comprising: a flexible body portion, the body portion comprising: a first destructible section; a second destructible section, the first destructible section and the second destructible section each having at least one weakness pattern provided therein; and a non-destructible section interposed between the first destructible section and the second destructible section and substantially devoid of any weakness pattern.

In one or more embodiments, the first destructible section is intended to overlie an anti-theft sensor, tag, other label or the like. In one form, the first destructible section has a weakness pattern provided therein that is different than or the same as the weakness pattern provided in the second destructible section.

In one or more embodiments, the first destructible section and second destructible section are fracturable in multiple directions.

In one or more embodiments, the non-destructible section is fracture-resistant in substantially all directions.

In one or more embodiments, the first destructible section, the second destructible section and the non-destructible section are formed of the same material or wherein at least some of the sections are formed of different materials.

In one or more embodiments, the theft deterrent label further comprises an adhesive layer on a bottom surface of the body portion.

In one or more embodiments, the weakness pattern provided in the first destructible section surrounds an interior region devoid of any weakness pattern, the interior region having a dimensional footprint larger than a dimensional footprint of the anti-theft sensor, tag, other label or the like to be overlaid.

In one or more embodiments, the theft deterrent label further comprises printed messaging and/or indicia on an upper surface of the body portion. In one form, the printed messaging and/or indicia is at least on the upper surface of the body portion within the first destructible section. In another form, an alignment feature is provided on the upper surface of the body portion within the non-destructible section.

In one or more embodiments, each weakness pattern comprises lines of perforations, holes and/or cuts provided in the body portion.

According to another aspect there is provided a theft deterrent label for affixing to merchandise package, comprising a fracture-resistant thin film layer having an adhesive layer on one major surface thereof, the thin film layer comprising a first destructible section and a second destructible section that are each fracturable in one or more of directions, and a non-destructible section separating the first and second destructible sections, the non-destructible section being fracture-resistant in substantially all directions.

In one or more embodiments, the first and second destructible sections have weakness patterns provided therein. In one form, the weakness patterns provided in the first and second destructible sections are one of (i) the same or (ii) different. In another form, the non-destructible section is substantially devoid of any weakness pattern.

In one or more embodiments, the theft deterrent label is generally rectangular in top plan and wherein the first and second destructible sections are longitudinally spaced apart and separated by the non-destructible section. In another form, the theft deterrent label is generally rectangular in top plan and wherein the first and second destructible sections extend longitudinally along the length of the theft deterrent label and are separated by the non-destructible section.

In one or more embodiments, the theft deterrent label further comprises printed messaging and/or indicia on an opposite major surface of the thin film layer. In one form, the printed messaging and/or indicia is at least on the opposite major surface within the first destructible section.

In one or more embodiments, the theft deterrent label further comprises an alignment feature on an opposite major surface of the thin film layer within the non-destructible section.

In one or more embodiments, each weakness pattern comprises lines of weakness provided in the thin film layer. In one form, the lines of weakness comprise zig-zag lines inwardly spaced from outer peripheral edges of the theft deterrent label. In another form, the lines of weakness further comprise spaced lines extending between the zig-zag lines and the outer peripheral edges of the theft deterrent label.

According to another aspect there is provided a theft deterrent label for affixing to merchandise packaging, comprising: a flexible body portion, the body portion comprising: a first destructible section intended to be affixed to a first surface of the merchandise packaging and overlie an anti-theft sensor thereby to trap the anti-theft sensor between the theft deterrent label and the first surface, the first destructible section having a dimensional footprint larger than a dimensional footprint of the anti-theft sensor; a second destructible section intended to be affixed to a second surface of the merchandise packaging, the first destructible section and the second destructible section each having at least one weakness pattern provided therein; and a first non-destructible section interposed between the first destructible section and the second destructible section and substantially devoid of any weakness pattern, the first non-destructible section intended to extend over an opening or seam in the merchandise packaging.

In one or more embodiments, the body portion further comprises a third destructible section having at least one weakness pattern provided therein and a second non-destructible section interposed between the first destructible section and the third destructible section, the second non-destructible section substantially devoid of any weakness pattern. In one form, the second destructible section is longitudinally separated from the first destructible section by the first non-destructible section and wherein the third destructible section extends longitudinally in parallel with the first destructible section. In another form, the second non-destructible section is intended to extend over the opening or seam in the merchandise packaging. In another form, each weakness pattern comprises lines of weakness provided in the body portion. In another form, the lines of weakness comprise zig-zag lines inwardly spaced from outer peripheral edges of the theft deterrent label.

In one or more embodiments, the weakness pattern provided in the first destructible section surrounds at least a portion of an interior region devoid of any weakness pattern, the interior region having a dimensional footprint larger than a dimensional footprint of the anti-theft sensor.

In one or more embodiments, the theft deterrent label of any one of paragraphs [0010] to [0026] is provided in combination with an anti-theft sensor.

In one or more embodiments, the theft deterrent label of any one of paragraphs [0010] to [0026] is provided in combination with an anti-theft sensor or the like and merchandise packaging.

### BRIEF DESCRIPTION OF THE DRAWINGS

Embodiments will now be described with reference to the accompanying drawings in which like reference characters are used to indicate like components and in which:

FIG. 1a is a top plan view of a theft deterrent label;

FIG. 1b is a side view of the theft deterrent label of FIG. 1a;

FIG. 2 is a top plan view of an anti-theft sensor;

FIG. 3 is a perspective view of packaging in the form of a box in a partially open condition;

FIG. 4 is another perspective view of the box of FIG. 3 in a closed condition with the theft deterrent label of FIG. 1a affixed thereto;

FIG. 5 is a top plan view of the box and theft deterrent label of FIG. 4;

FIG. 6 is a cross-sectional view of the lid of the box of FIG. 5 taken along line 6-6;

FIG. 7 is a perspective view of packaging in the form of an alternative box in a partially open condition;

FIG. 8 is another perspective view of the box of FIG. 8 with the theft deterrent label of FIG. 1a partially affixed thereto;

FIG. 9 is another perspective view of the box of FIG. 8 with the theft deterrent label fully affixed thereto;

FIG. 10 is a top plan view of an alternative theft deterrent label;

FIG. 11 is a perspective view of packaging in the form of yet another box in a partially open condition and with the theft deterrent label of FIG. 10 partially affixed thereto;

FIG. 12 is a perspective view of the box of FIG. 11 in a closed condition and with the theft deterrent label of FIG. 10 fully affixed thereto;

FIG. 13 is a top plan view of yet another theft deterrent label;

FIG. 14 is a top plan view of yet another theft deterrent label;

FIGS. 15a to 15d are perspective views of packaging in the form of a box with the theft deterrent label of FIG. 14 fully affixed thereto at different locations on the box; and

FIGS. 16a to 16f show different weakness patterns for use in theft deterrent labels.

### DETAILED DESCRIPTION

The foregoing summary, as well as the following detailed description of certain examples, will be better understood when read with the accompanying drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings.

As used herein, the term “and/or” can include any and all combinations of one or more of the associated listed elements or features.

It will be understood that when an element or feature is referred to as being, for example, “on”, “attached” to, “connected” to, “coupled” with, “contacting”, “affixed” to, etc. another element or feature, that element or feature can be directly on, attached to, connected to, coupled with, contacting or affixed to the other element or feature or intervening elements may also be present. In contrast, when an element or feature is referred to as being, for example, “directly on”, “directly attached” to, “directly connected” to, “directly coupled” with, “directly contacting”, “directly affixed” to, etc. another element or feature, there are no intervening elements or features present.

Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

It will be understood that spatially relative terms, such as “under”, “below”, “lower”, “over”, “above”, “upper”, “front”, “back”, “top”, “bottom” and the like, may be used herein for ease of description to describe the relationship of an element or feature to another element or feature as illustrated in the figures. The spatially relative terms can however, encompass different orientations in use or operation in addition to the orientations depicted in the figures.

As used herein, the term “configured” means that the element, component, or other subject matter is designed and/or intended to perform a given function. Thus, the use of the term “configured” should not be construed to mean that a given element, component, or other subject matter is simply “capable of” performing a given function but that the element, component, and/or other subject matter is specifically selected, created, implemented, utilized, and/or designed for the purpose of performing the function. Subject matter that is described as being configured to perform a particular function may additionally or alternatively be described as being operative or adapted to perform that function.

Unless otherwise indicated, the terms “first,” “second,” “third,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately”, “about”, “substantially”, “generally”, etc. represent an amount or condition close to the stated amount or condition (i.e. a permissible variation) that still results in the desired function being performed or the desired result being achieved. For example, the terms “approximately”, “about”, “substantially”, “generally” etc. may refer to an amount or condition that is within engineering tolerances to the precise value or condition specified that would be readily appreciated by a person skilled in the art.

In general, a theft deterrent label is described and comprises a flexible body portion that at least comprises first and second destructible sections separated by a non-destructible section. The first and second destructible sections have weakness patterns provided therein which allow the first and second destructible sections to fracture in one or more directions. The non-destructible section is substantially devoid of any weakness pattern and as a result is fracture-resistant in substantially all directions. The first and second destructible sections are difficult to peel from packaging when adhered thereto due to their propensity to fracture. The non-destructible section is difficult to cut due its fracture resistance. Exemplary theft deterrent labels will now be further described with reference to the figures.

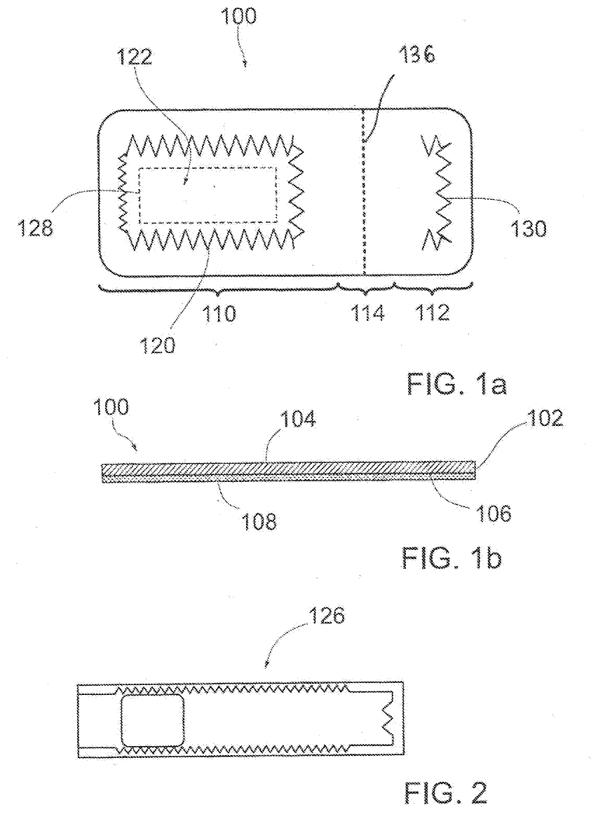

Turning now to FIGS. 1a and 1b, a theft deterrent label is shown and is generally identified by reference number 100. In this embodiment, the theft deterrent label 100 is configured to be used in conjunction with an anti-theft sensor, such as an Acousto-Magnetic (AM) sensor or Radio Frequency (RF) anti-theft sensor. In use, the theft deterrent label 100 is configured to overlie and trap the anti-theft sensor between the theft deterrent label 100 and merchandise packaging thereby to inhibit direct access to the anti-theft sensor as well as to extend across and seal an opening or seam of the merchandize packaging to inhibit opening of the merchandise packaging as will be described. For example, the merchandise packaging may be a box, carton, container, parcel, folder, etc.

As can be seen, the theft deterrent label 100 in this embodiment is generally rectangular in plan and comprises a flexible body formed of a thin film layer 102 having a major upper surface 104 and an opposite major bottom surface 106. The thin film layer 102 is formed of plastic material, such as polyester, generally having a resistance to fracturing in all directions. In this embodiment, the thin film layer 102 has a thickness in the range of from about 0.0005 inches to about 0.002 inches. As will be appreciated, gaining access to edges of the theft deterrent label 100 becomes more difficult as label thickness decreases. That said, those of skill in the art will appreciate that the thin film layer may have a thickness greater than or less than the above stated range.

A thin or ultra-thin layer of aggressive, high tack adhesive 108 is provided on the major bottom surface 106 to allow the theft deterrent label 100 to be firmly affixed to the merchandise packaging with the anti-theft sensor trapped between the theft deterrent label 100 and the merchandise packaging. The adhesive layer 108 is common to the label industry and works well both at room temperatures and at low (i.e., freezer) temperatures.

The theft deterrent label 100 has a relatively small footprint to minimize its impact on aesthetics and/or printed areas of the merchandise packaging to which it is affixed. In this embodiment, the dimensions of the theft deterrent label are 3½ inches by 1⅜ inches. Those of skill in the art will however appreciate that the geometric shape and dimensions of the theft deterrent label 100 can be varied as needed to suit the environment in which the theft deterrent label 100 is deployed.

The thin film layer 102 comprises a plurality of sections or regions. In this embodiment, the thin film layer 102 comprises three (3) sections, namely a first destructible section 110, a second destructible section 112, and a non-destructible section 114 interposed between the first and second destructible sections 110 and 112. The resistance to fracturing of the thin film layer 102 in the first and second destructible sections 110 and 112 is deliberately compromised while the resistance to fracturing of the thin film layer 102 in the non-destructible section 114 is maintained substantially fully intact.

The first destructible section 110 is the primary or largest of the three sections and is generally rectangular in plan. Formations of weakness in the form of small discrete perforations (e.g. punctures, holes etc.) are provided through the thin film layer 102 in the first destructible section 110 and are arranged to form a weakness pattern. In this embodiment, the weakness pattern is in the form of a substantially continuous, generally rectangular ring 120 having an outer periphery that is inwardly spaced from the outer peripheral edges of the theft deterrent label 100. The generally rectangular ring 120 surrounds an interior region 122 that is devoid of any formations of weakness. The sides of the generally rectangular ring 120 are defined by lines of discrete perforations that zig-zag. The configurations of the zig-zag or saw-tooth lines defining the long sides of the generally rectangular ring 120 are substantially the same. The configurations of the zig-zag lines defining the short sides of the generally rectangular ring 120 are different from each other and are different from the zig-zag lines defining the long sides of the generally rectangular ring 120. In particular, the pattern of the zig-zag line adjacent the free end of the theft deterrent label 100 has a smaller amplitude and higher frequency than the pattern of the zig-zag line adjacent the non-destructive section 114.

The interior region 122 is configured to overlie and may obscure an anti-theft sensor 126 (see FIG. 2) when the theft deterrent label 100 is affixed to merchandise packaging as will be described. To achieve this, the interior region 122 has dimensions larger than the dimensions of the anti-theft sensor 126 (i.e. the interior region 122 has a larger dimensional footprint than the dimensional footprint of the anti-theft sensor 126).

Printed messaging and/or indicia designated by the dotted lines 128 may be provided on the upper major surface 102 of the thin film layer 102 within the interior region 122. The printed messaging and/or indicia make take a variety of forms. For example, the printed messaging and/or indicia may provide a warning to shoplifters of the existence of the anti-theft sensor 126. Alternatively or in addition to, the printed messaging and/or indicia may include logos, advertising, or other information. As will be appreciated, the printed messaging and/or indicia aids in camouflaging the anti-theft sensor 126 over which the theft deterrent label 100 rests.

The second destructible section 112 is secondary or smaller and is generally rectangular in plan. The second destructible section 112 is positioned adjacent one end of the first destructible region 110 and acts as a foldable tab or wing. Formations of weakness in the form of small discrete perforations (e.g. punctures, holes etc.) are provided through the thin film layer 102 in the second destructible section 112. In this embodiment, the discrete perforations are arranged to form a weakness pattern in the form of a shallow “U” 130 having an outer periphery that is inwardly spaced from the outer peripheral edges of the theft deterrent label 100. The arms and bight of the shallow “U” are defined by lines of discrete perforations that zig-zag. The zig-zag lines are generally consistent over the shallow “U” 130. Printed messaging and/or indicia (e.g. a logo, advertising, etc.) may also be provided on the upper major surface 102 of the thin film layer 102 within the second destructible section 112.

The non-destructible section 114 is positioned between and longitudinally separates the first destructible section 110 and the second destructible section 112. The non-destructible section 114 is constituted by a region of the thin film layer 102 substantially devoid of any formations of weakness. The non-destructible section 114 comprises a printed alignment mark 136 in the form of a dashed line that extends substantially across the width of the theft deterrent label 100.

As mentioned above, the theft deterrent label 100 is configured to overlie and trap the anti-theft sensor 126, such as an Acousto-Magnetic (AM) sensor or Radio Frequency (RF) anti-theft sensor, between the theft deterrent label 100 and merchandise packaging as well as to extend across and seal an opening or seam of the merchandise packaging.

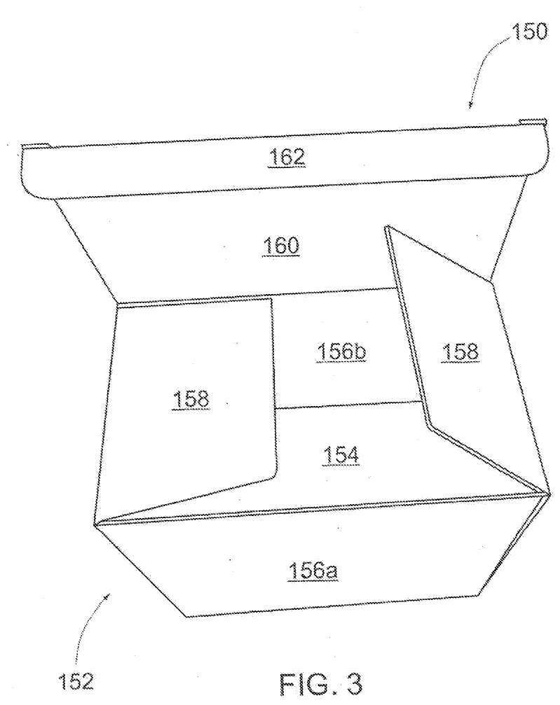

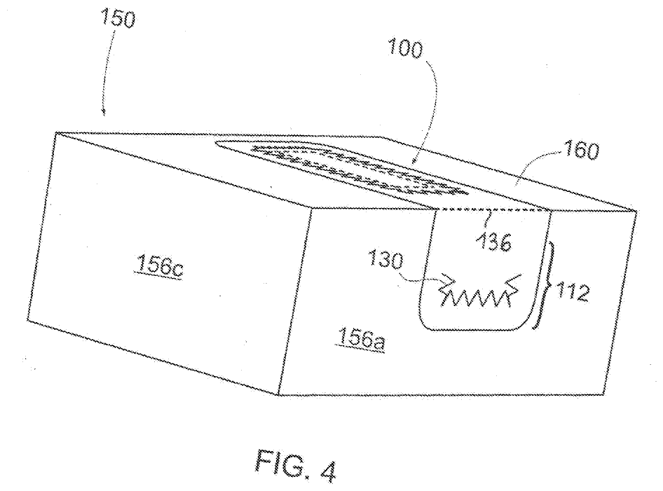

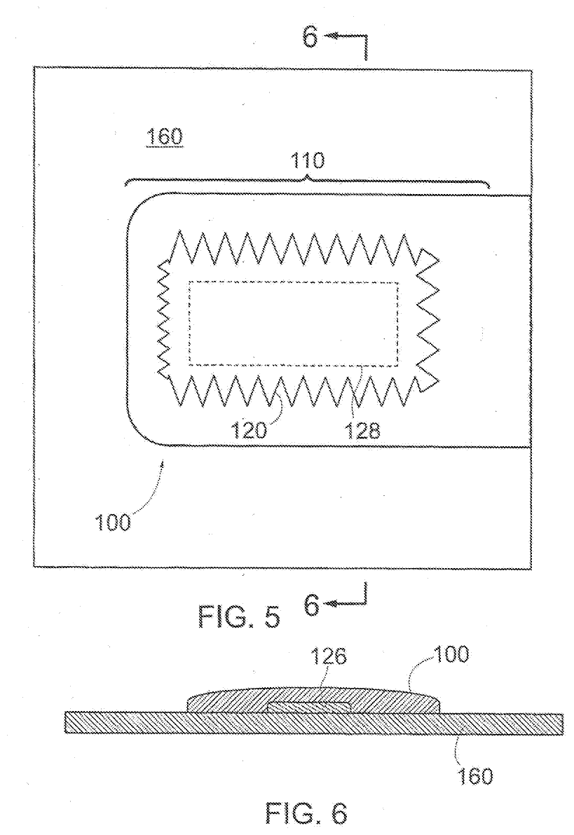

For example, turning now to FIGS. 3 to 6, merchandise packaging in the form of a box 150 is shown. The box 150 in this embodiment is rectangular in plan and has a box body 152 comprising a base 154, upstanding front, rear and side walls 156a, 156b and 156c, respectively, upper closure flaps 158 hingedly connected to the side walls 156c and a lid 160 hingedly connected to the rear wall 156b. A flange 162 depends from the forward peripheral edge of the lid 160. The lid 160 can be pivoted upwardly relative to the box body 152 to expose the interior of the box 150 and any contents therein as shown in FIG. 3 and can be pivoted downwardly towards the box body 152 to close the box 150 with the flange 162 tucked into the box 150 behind the front wall 156a as shown in FIGS. 4 and 5.

To make access to the interior of the box 150 difficult and time consuming and thereby provide theft deterrence, the theft deterrent label 100 can be affixed to the box 150 via the adhesive layer 108 as shown in FIGS. 4 to 6. In this embodiment, the theft deterrent label 100 is positioned so the first destructible section 110 is affixed to the lid 160 of the box 150 with the interior region 122 overlying the anti-theft sensor 126. Because the interior region 122 has larger dimensions than the anti-theft sensor 126, the interior region 122 completely surrounds the anti-theft sensor 126 and adheres to the lid 160 about the entire periphery of the anti-theft sensor 126. As a result, direct access to the anti-theft sensor 126 is inhibited. The alignment mark 136 facilitates alignment of the non-destructible section 114 with the opening or seam of the box 150 between the lid 160 and the box body 152. The second destructible section 112, which is oriented generally at a 90 degree angle with respect to the first destructible section 110, is affixed to the front wall 156a of the box 150.

During application of the theft deterrent label 100 to the box 150, the first destructible section 110 may be initially affixed to the lid 160 of the box 150 with the anti-theft sensor 126 trapped between the first destructible section 110 and the lid 160 and then the theft deterrent label 100 may be folded downwardly to affix the second destructible section 112 to the front wall 156a of the box 150. Those of skill in the art will however appreciate that the theft deterrent label 100 may be affixed to the box 150 in the reverse order; that is the second destructible section 112 may be initially affixed to the front wall 156a of the box 150 and then the theft deterrent label 100 may be folded over to affix the first destructible section 110 to the lid 160 of the box 150. Of course, both the first and second destructible sections 110 and 112, respectively, can be affixed to the lid 160 and front wall 156a basically simultaneously.

Those of skill in the art will appreciate that the theft deterrent label 100 may alternatively be affixed to the lid 160 and one of the side walls 156c of the box 150. Also, the orientation of the theft deterrent label 100 may be reversed so that the first destructible section 110 is affixed to the front wall 156a or to one of the side walls 156c of the box 150 and the second destructible section 112 is affixed to the lid 160 of the box 150.

Because the theft deterrent label 100 comprises a thin film layer 102, it is difficult to grab or gain a fingerhold on any of the edges of the theft deterrent label 100 making the theft deterrent label 100 difficult to remove from the box 150. If an edge fingerhold is obtained on any edge of the theft deterrent label 150 in either the first or second destructible sections 110 and 112, respectively, and an attempt is made to peel the theft deterrent label 100 from the box 150, the weakness patterns defined by the formations of weakness cause the theft deterrent label to fracture in one or more directions making the exercise of peeling the theft deterrent label 100 from the box 150 time consuming as multiple attempts are required. The non-destructible section 114 which extends across the opening or seam between the lid 160 and the box body 152 retains its inherent strength due to the absence of any formations of weakness making the theft deterrent label 100 difficult to cut at the opening or seam.

As will be appreciated, the theft deterrent label 100 combines the inherent strength and thickness of the film layer 102, the weakness patterns, and the bonding strength of the adhesive layer 108 to combat shoplifting attempts while providing robust sealing capabilities. In particular, the inherent strength and thickness of the film layer 102 and the bonding strength of the adhesive layer 108 ensure that it will be difficult to grab an edge of the theft deterrent label 100 in an attempt to peel the theft deterrent label 100 from merchandise packaging. Should an attempt to peel the theft deterrent label 100 from merchandise packaging be successful, the weakness patterns defined by the formations of weakness ensure that the theft deterrent label 100 fractures in one or more directions thereby to thwart peeling of the theft deterrent label 100 from the merchandise packaging.

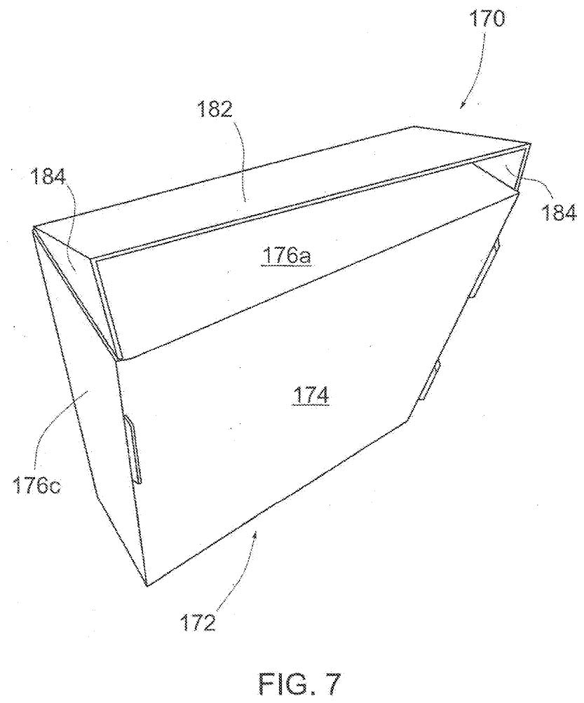

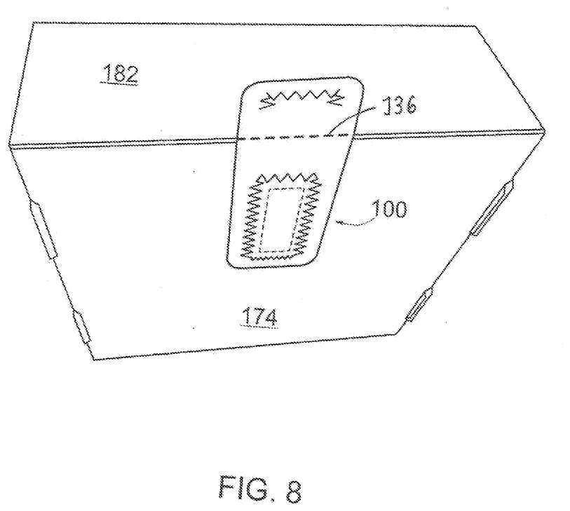

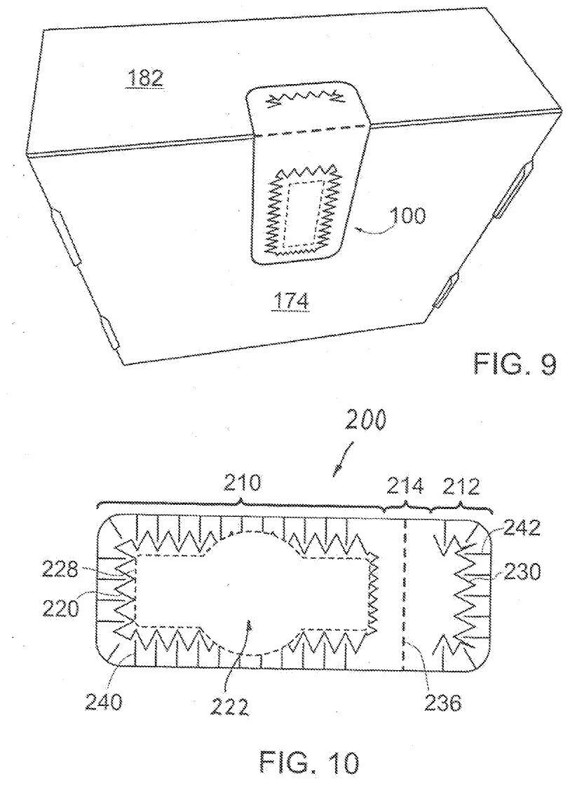

As will be appreciated by those of skill in the art, the theft deterrent label 100 is suitable for use on other forms of merchandise packaging. For example, turning now to FIGS. 7 to 9, merchandise packaging in the form of an alternative box 170 is shown. The box 170 in this embodiment is rectangular in plan and has a box body 172 and a lid (not visible) hingedly connected to the box body 172. A panel 182 depends from the forward peripheral edge of the lid and has a pair of wings 184 at opposite ends thereof that are received in openings between the front wall 176a of the box 170 and the side walls 176c of the box. The panel 182 can be pivoted relative to the lid of the box 170 to remove the wings 184 from the openings (as partially shown in FIG. 7) thereby to allow the lid to be pivoted upwardly relative to the box body 172 to expose the interior of the box 170 and any contents therein. In the closed position as shown in FIGS. 8 and 9, the panel 182 overlies the front wall 176a of the box 170 and the wings 184 are fully received in the openings between the front wall 176a and the side walls 176c of the box.

To make access to the interior of the box 170 difficult and time consuming and thereby provide theft deterrence, the theft deterrent label 100 can be affixed to the box 170 via the adhesive layer 108 as shown in FIGS. 8 and 9. In this embodiment, the theft deterrent label 100 is positioned so the first destructible section 110 is affixed to the base 174 of the box 170 with the interior region 122 overlying the anti-theft sensor 126. The alignment mark 136 facilitates alignment of the non-destructible section 114 with the opening or seam between the panel 182 and the front wall 176a of box body 152. The second destructible section 112, which is oriented generally at a 90 degree angle with respect to the first destructible section 110, is affixed to the panel 182 that overlies the front wall 176a of the box 150.

As shown in FIG. 8, during application of the theft deterrent label 100 to the box 170, the first destructible section 110 is initially affixed to the base 174 of the box 170 with the anti-theft sensor 126 trapped between the first destructible section 110 and the base 174 and then the theft deterrent label 100 is folded over to affix the second destructible section 112 to the panel 182 thereby to fully affix the theft deterrent label 100 to the box 170. Those of skill in the art will however appreciate that the theft deterrent label 100 may be affixed to the box 170 in the reverse order; that is the second destructible section 112 may be initially affixed to the panel 182 and then the theft deterrent label 100 may be folded to affix the first destructible section 110 to the base 174 thereby to fully affix the theft deterrent label 100 to the box 170. Of course, both the first and second destructible sections 110 and 112, respectively, can be affixed to the base 174 and panel 182 basically simultaneously. Also, those of skill in the art will appreciate that the theft deterrent label 100 may be affixed to the box 170 at other locations.

Turning now to FIG. 10, an alternative theft deterrent label is shown and is generally identified by reference numeral 200. Similar to the previous embodiment, the theft deterrent label 200 comprises a thin film layer formed of plastic material, such as polyester. A thin or ultra-thin layer of aggressive, high tack adhesive is provided on the bottom major surface of the thin film layer to allow the theft deterrent label 200 to be firmly affixed to merchandise packaging with the anti-theft sensor trapped between the theft deterrent label 200 and the merchandise packaging.

As will be appreciated, the theft deterrent label 200 is very similar to the theft deterrent label 100 shown in FIGS. 1a and 1b; the differences being the weakness patterns defined by the formations of weakness in the first and second destructible sections 210 and 212, respectively, and the footprint of the printed messaging and/or indicia designated by the dotted lines 228.

In this embodiment, the discrete perforations provided in the first destructible section 210 are similarly arranged to form a weakness pattern in the form a substantially continuous, generally rectangular ring 220 having an outer periphery that is inwardly spaced from the peripheral edges of the theft deterrent label 200. The generally rectangular ring 220 surrounds an interior region 222 that is devoid of any formations of weakness. The sides of the generally rectangular ring 120 are defined by lines of discrete perforations that zig-zag. The configurations of the zig-zag lines defining the long sides of the generally rectangular ring 220 and the short side of the generally rectangular ring adjacent one end of the theft deterrent label 200 are substantially the same. The configuration of the zig-zag line defining the other short side of the generally rectangular ring 120 is different. In particular, the pattern of the zig-zag line adjacent the non-destructive section 214 has a smaller amplitude and higher frequency than the pattern of the other zig-zag lines. In addition to the zig-zag lines that form the generally rectangular ring 220, discrete perforations are also arranged to form a series of spaced, straight lines 240 that extend inwardly from the outer peripheral edges of the theft deterrent label 200 towards the generally rectangular ring 220. In this embodiment, the lines 240 do not intersect the generally rectangular ring 220.

The discrete perforations provided in the second destructible section 212 are arranged to form a weakness pattern in the form a shallow “U” 230 having an outer periphery that is inwardly spaced from the outer peripheral edges of the theft deterrent label 200. The arms and the bight of the shallow “U” are defined by zig-zag lines of discrete perforations that are generally consistent over the shallow ‘U” 230 and similar to the zig-zag lines forming the generally rectangular ring 220. In addition to the zig-zag lines that form the shallow “U”, discrete perforations are also arranged to form a series of spaced, straight lines 242 that extend inwardly from the outer peripheral edges of the theft deterrent label 200 towards the shallow “U” 230. In this embodiment, the lines 242 do not intersect the shallow “U” 230.

The printed messaging and/or indicia 228 on the upper surface of the first destructible section 210 in this embodiment has a larger footprint than in the previous embodiment and extends over part of the generally rectangular ring 220.

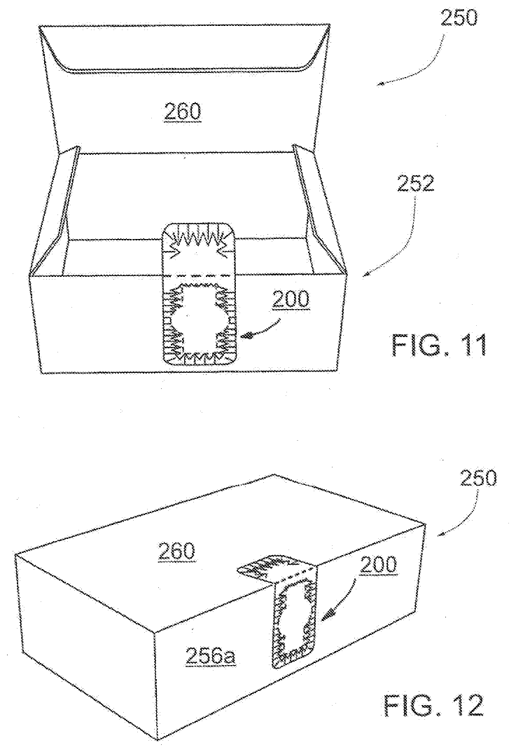

FIGS. 11 and 12 show the theft deterrent label 200 affixed to merchandise packaging in the form of a box 250 that is similar to box 150 shown in FIGS. 3 to 5. As shown in FIG. 11, during application of the theft deterrent label 200 to the box 250, the first destructible section 210 is initially affixed to the front wall 256a of the box 250 with the anti-theft sensor trapped between the first destructible section 210 and the front wall 256a and then the theft deterrent label 200 is folded over to affix the second destructible section 212 to the lid 260 of the box thereby to fully affix the theft deterrent label 200 to the box 250 with the non-destructible section 214 extending over an opening or seam of the box 250. Those of skill in the art will however appreciate that the first and second destructible sections 210 and 212 of the theft deterrent label 200 may be affixed to the box 170 in the reverse order or basically simultaneously. Also, those of skill in the art will appreciate that the theft deterrent label 200 may be affixed to the box 250 at other locations.

Similar to the previous embodiment, the theft deterrent label 200 makes access to the interior of the box 250 difficult and time consuming thereby to provide theft deterrence. The weakness patterns comprising the zig-zag lines in conjunction with the spaced lines 240 and 242 enhances fracturing of the first and second destructible sections 210 and 212 when attempts are made to peel these sections of the theft deterrent label 200 from merchandise packaging. Like the previous embodiment, the non-destructible section 214, which extends across an opening or seam of the merchandise packaging when the theft deterrent label 200 is deployed, is difficult to cut thereby to inhibit opening of the merchandise packaging.

Turning now to FIG. 13, yet another theft deterrent label is shown and is generally identified by reference numeral 300. Similar to the previous embodiments, the theft deterrent label 300 comprises a thin film layer formed of plastic material, such as polyester. A thin or ultra-thin layer of aggressive, high tack adhesive is provided on the bottom major surface of the thin film layer to allow the theft deterrent label 300 to be firmly affixed to merchandise packaging with the anti-theft sensor trapped between the theft deterrent label 400 and the merchandise packaging.

As will be appreciated, the theft deterrent label 300 is also similar to theft deterrent label 100 shown in FIGS. 1a and 1b. In this embodiment, the second destructible section 312 extends longitudinally along one side of (i.e. in parallel with) the first destructible section 310. The non-desctructible section 314 is interposed between and separates the first and second non-destructible sections 310 and 312. The non-destructible section 314 comprises a printed alignment mark 336 in the form of a dashed line that extends substantially across the length of the theft deterrent label 300.

The discrete perforations provided in the first destructible section 310 are arranged to form a weakness pattern in the form a discontinuous, generally rectangular ring 320 having an outer periphery that is inwardly spaced from the peripheral edges of the theft deterrent label 300. The generally rectangular ring 320 surrounds an interior region 322 that is devoid of any formations of weakness. The sides of the generally rectangular ring 320 are defined by lines of discrete perforations that zig-zag. The configurations of the zig-zag lines defining the short sides of the generally rectangular ring 320 and the long side of the generally rectangular ring 320 adjacent one side of the theft deterrent label 300 are substantially the same. The configuration of the zig-zag line defining the other long side of the generally rectangular ring 320 is different. In particular, the pattern of the zig-zag line adjacent the non-destructive section 314 has a smaller amplitude and higher frequency than the pattern of the other zig-zag lines. In addition to the zig-zag lines that form the generally rectangular ring 320, discrete perforations are also arranged to form a series of spaced, straight lines 340 that extend inwardly from the outer peripheral edges of the theft deterrent label 300 towards the generally rectangular ring 320. In this embodiment, the lines 340 do not intersect the generally rectangular ring 320 and do not extend to the outer peripheral edges of the theft deterrent label 300.

The discrete perforations provided in the second destructible section 312 are arranged to form a weakness pattern in the form a very shallow “U” 330 having an outer periphery that is inwardly spaced from the outer peripheral edges of the theft deterrent label 300. The arms and the bight of the shallow “U” are defined by zig-zag lines of discrete perforations that are generally consistent over the shallow ‘U” 330. In addition to the zig-zag lines that form the shallow “U”, discrete perforations are also arranged to form a series of spaced, straight lines 342 that extend inwardly from the outer peripheral edges of the theft deterrent label 300 towards the shallow “U” 330. In this embodiment, the lines 342 do not intersect the shallow “U” 330 and do not extend to the outer peripheral edges of the theft deterrent label 300.

In the above-embodiments, the weakness patterns provided in the first destructible sections 110 and 210 form substantially continuous, generally rectangular rings. Those of skill in the art will appreciate that the discrete perforations need not be arranged to from continuous rings. The rings may be discontinuous. Also, the rings need not be rectangular in shape. The rings may take other suitable geometric or complex shapes. Similarly, the weakness patterns provided in the second destructible sections 112 and 212 need not be arranged to form shallow “U”s. The discrete perforations can be arranged to take other suitable shapes or forms.

In the embodiments described above, the theft deterrent labels comprise two destructible sections 110 and 112 allowing the theft deterrent labels to overlie anti-theft sensors as well as bridge openings or seams of merchandise packaging to act as seals. Theft deterrent labels with additional destructible sections are of course possible.

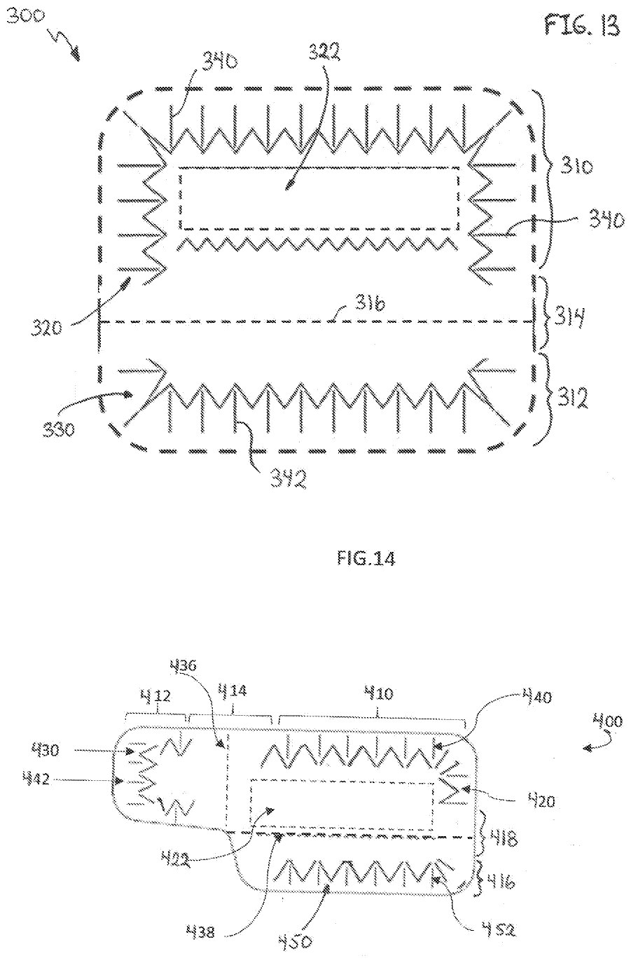

For example, turning now to FIG. 14, another embodiment of a theft deterrent label is shown and is generally identified by reference numeral 400. In this embodiment, the theft deterrent label 400 is configured to overlie an anti-theft sensor and trap the anti-theft sensor between the theft deterrent label 400 and merchandise packaging thereby to inhibit direct access to the anti-theft sensor as well as to extend across and seal an opening or seam of the merchandise packaging at multiple locations as will be described.

Similar to the previous embodiments, the theft deterrent label 400 comprises a thin film layer formed of plastic material, such as polyester. A thin or ultra-thin layer of aggressive, high tack adhesive is provided on the bottom major surface of the thin film layer to allow the theft deterrent label 400 to be firmly affixed to merchandise packaging with the anti-theft sensor trapped between the theft deterrent label 400 and the merchandise packaging.

The thin film layer of the theft deterrent label 400 comprises a plurality of section or regions. In this embodiment, the thin film layer comprises a first or primary destructible section 410, a second destructible section 412 that acts as a foldable tab or wing adjacent one end of the first destructible region 410, a first non-destructible section 414 interposed between the first and second destructible sections 410 and 412, a third destructible section 416 extending longitudinally along one side of the first destructible region 410 that acts as a tab or wing, and a second non-destructible section 418 interposed between the first and third destructible sections 410 and 416. The resistance to fracturing of the theft deterrent label 400 in the first, second and third destructible sections 410, 412, and 416, respectively, is deliberately compromised while the resistance to fracturing of the theft deterrent label 400 in the first and second non-destructible sections 414 and 418 is maintained substantially fully intact.

In this embodiment, discrete perforations arranged to form a weakness pattern 420 in the shape of an “L” are provided in the first destructible section 410. The weakness pattern 420 partially surrounds an interior region 422 that is substantially devoid of any formations of weakness. The arms of the weakness pattern 420 are defined by similar lines of discrete perforations that zig-zag. In addition to the zig-zag lines, discrete perforations are also arranged to form a series of spaced, straight lines 440 that extend inwardly from the outer peripheral edges of the theft deterrent label 400 towards the zig-zag lines. In this embodiment, the lines 440 do not intersect the zig-zag lines and do not extend to the outer peripheral edges of the theft deterrent label 400.

Printed messaging and/or indicia may be provided on the upper major surface of the thin film layer within the interior region 422. The printed messaging and/or indicia make take a variety of forms. For example, the printed messaging and/or indicia may provide a warning to shoplifters of the existence of the anti-theft sensor. Alternatively or in addition to, the printed messaging and/or indicia may include logos, advertising, or other information.

Discrete perforations arranged to form a weakness pattern 430 in the shape of a “U” are provided in the second destructible section 412. The arms and bight of the weakness pattern 430 are defined by similar lines of discrete perforations that zig-zag. In addition to the zig-zag lines, discrete perforations are also arranged to form a series of spaced, straight lines 442 that extend inwardly from the outer peripheral of the theft deterrent label 400 towards the zig-zag lines. In this embodiment, the lines 442 do not intersect the zig-zag lines and do not extend to the outer peripheral edges of the theft deterrent label 400.

Discrete perforations arranged to form a linear weakness pattern 450 are provided in the third destructible section 416. The linear weakness pattern 450 is defined by a line of discrete perforations that zig-zags. In addition to the zig-zag line, discrete perforations are also arranged to form a series of spaced, straight lines 452 that extend inwardly from the outer peripheral edges of the theft deterrent label 400 towards the zig-zag line. In this embodiment, the lines 452 do not intersect the zig-zag line and do not extend to the outer peripheral edges of the theft deterrent label 400.

The non-destructible section 414 comprises a printed alignment mark 436 in the form of a dashed line that extends substantially across the width of the non-destructible section 414. The non-destructible section 418 comprises a printed alignment mark 438 in the form of a dashed line that extends substantially along the length of the third destructible section 418. The alignment marks 446 and 448 are configured to be aligned with an opening or seam in merchandise packaging when the theft deterrent label 400 is adhered to the merchandise packaging at multiple locations and therefore, facilitate placement of the theft deterrent label 400 in use.

FIGS. 15a to 15d show the theft deterrent label 400 affixed to merchandise packaging in the form of a box 450 that is similar to box 150 shown in FIGS. 3 to 5. As shown in FIG. 15a, the theft deterrent label 400 is affixed to the box 450, adjacent its front left hand corner. As illustrated, the first destructible section 410 is affixed to the lid 460 of the box 450 with the anti-theft sensor trapped between the first destructible section 410 and the lid of the box 450. The second destructible section 412 is folded over and affixed to the front 456c of the box 450 and the third destructible section 416 is folded over and affixed to the left side 456a of the box 450. The non-destructible sections 414 and 418 extend across the opening or seam, between the lid 460 and front 456c of the box 450 and between the lid 460 and left side 456c. In FIG. 15b, the theft deterrent label 400 is affixed to the box 450 adjacent its front right hand corner. As illustrated, the first destructible section 410 is affixed to the right side 456c of the box 450 with the anti-theft sensor trapped between the first destructible section 410 and the right side. The second destructible section 412 is folded over and affixed to the front 456a of the box and the third destructible section 416 is folded over and affixed to the lid 460 of the box 450. As will be appreciated, the configuration of the theft deterrent label 400 makes it particularly suitable for affixing adjacent corners of merchandise packaging as the second and third destructible sections are able to bridge merchandise packaging openings or seams at multiple locations.

The theft deterrent label 400 however does not need to be positioned adjacent a corner of the box. For example, in FIG. 15c, the first and second destructible sections 410 and 412 are affixed to the lid 460 of the box 450 with the anti-theft sensor trapped between the first destructible section 410 and the lid. The third destructible section 416 is folded over and affixed to the front wall 456a of the box 450. In FIG. 15d, the first and third destructible sections 410 and 416 are affixed to the lid 460 of the box 450 with the anti-theft sensor trapped between the first destructible section 410 and the lid. The second destructible section 412 is folded over and affixed to the front wall 456a of the box 450.

In the above embodiments, in the first, second and third destructible sections, the discrete perforations are arranged to form zig-zag lines. Those of skill in the art will appreciate that the discrete perforations may be arranged to form different shaped lines or different shapes and/or patterns. In fact, discrete perforations may be arranged to define short, straight, curved or angled lines, circles or half or quarter circles, triangles, “Y” shapes, etc. or combinations thereof that can be arranged in the desired patterns in first and second destructible sections.

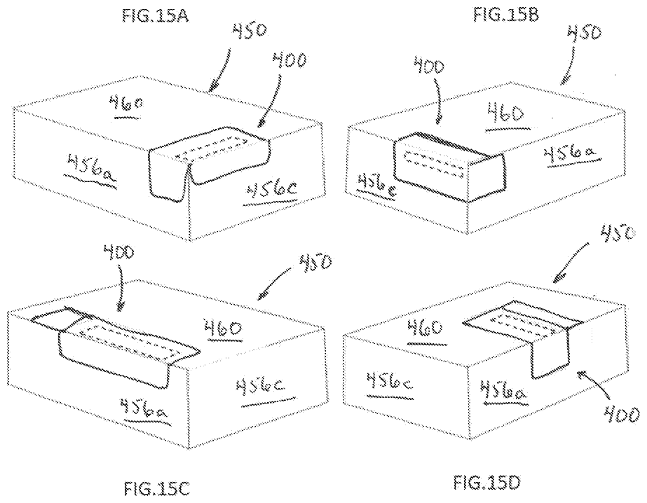

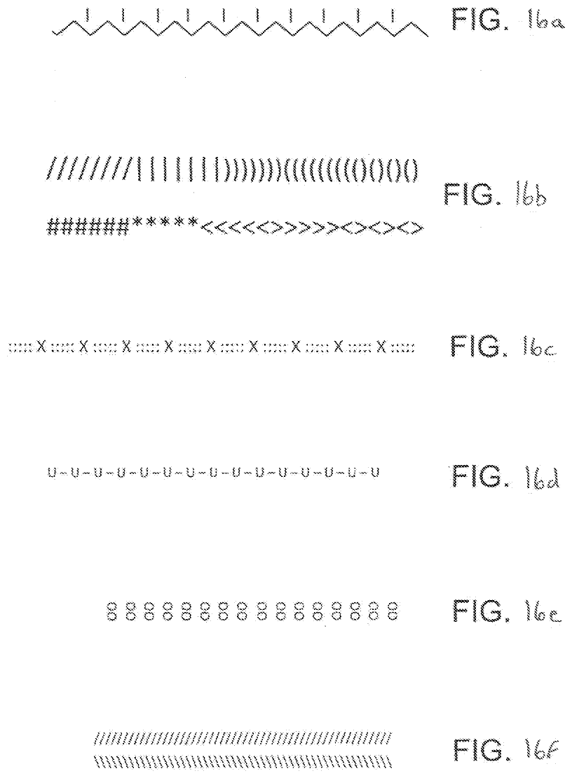

For example, FIGS. 16a to 16f show alternative discrete perforation arrangements that may be used to form weakness patterns in the first and second destructible sections. In FIG. 16a, the discrete perforations are arranged in a manner similar to those in the theft deterrent label 200 and define a combination of saw-toothed (zig-zag) and straight lines. In FIG. 16b, the discrete perforations are arranged to define discrete, spaced, straight and curved lines and special characters. In FIG. 16c, the discrete perforations are arranged to define discrete, spaced, crisscrossed lines separated by parallel dashed lines. In FIG. 16d, the discrete perforations are arranged to define discrete, spaced, “U”s separated by dashes. In FIG. 16e, the discrete perforations are arranged to define discrete, spaced, circles or ovals. In FIG. 16f, the discrete perforations are arranged to define discontinuous, spaced slanted lines. Those of skill in the art will appreciate that other line configurations and shapes may be employed. Also combinations of different line configurations and shapes may be used.

Although the interior regions within the first destructible sections are devoid of any weakness pattern, those of skill in the art will appreciate that the weakness patterns may extend further inwardly within the first destructible sections. Also, while the weakness patterns are described as being formed by arranging small discrete perforations such as punctures or holes in the desired patterns, those of skill in the art will appreciate that the weakness patterns may be defined by cuts formed in the destructible sections or by a combination of perforations and cuts.

The weakness patterns may be configured to allow the theft deterrent labels to tear into unidirectional strips when an attempt is made to peel the theft deterrent labels from the merchandise packaging thereby making it difficult and time consuming to peel off the theft deterrent label from the merchandise.

Although the thin film layer is described as being formed of polyester, in one or more embodiments, the theft deterrent labels may be formed of a material whose strength properties are orientation dependent. For instance, the material may be fracture-resistant in one direction and fracturable in another direction. Alternatively, those of skill in the art will appreciate that the theft deterrent labels may be formed of other suitable material. For example, other plastic films such as Tyvek may be employed. Alternatively, papers, coextruded composites and composites of paper, plastic film and woven fabric may be used. Similarly, although theft deterrent labels have been described as comprising a thin film layer formed of a single material, those of skill in the art will appreciate that different materials may be employed. For example, some sections of the theft deterrent labels may be formed of one type of material and other sections may be formed of another material or each section may be formed of a different material. In this case, different materials such as polystyrene, polypropylene, and acetate in addition to the materials previously described above, having the appropriate theft deterrent characteristics may be employed. The different materials may be adhered together adjacent their borders or laminated.

Although the theft deterrent labels have been described as carrying printed messages and/or indicia, those of skill in the art will appreciate that the theft deterrent labels may be devoid of printed messages and/or indicia. Likewise, the theft deterrent labels may be devoid of alignment marks.

The theft deterrent labels as described function as anti-theft devices by deterring unauthorized removal of anti-theft sensors. Furthermore, the theft deterrent labels inhibit unauthorized interchanging of the content of merchandise packaging. As will be appreciated, the theft deterrent labels may include other anti-theft deterrent components including visible warning messaging and/or indicia.

The theft deterrent labels are ideal for in-store labelling on products that are not well suited to source tagging. Although the theft deterrent labels have been described for use with anti-theft sensors, those of skill in the art will appreciate that the theft deterrent labels may be used in other applications. In essence, the theft deterrent labels can used in combination with any label, sensor or other device to be affixed to merchandise packaging. For example, the theft deterrent labels can be used to overlie RFID labels, authentication labels, or other structure etc.

As will be appreciated, the theft deterrent labels described above offer several advantages. The theft deterrent labels provide an excellent seal around their peripheral edges making them difficult to peel away from the merchandise packaging to which they are adhered. The theft deterrent labels fracture easily when a fingernail or other tool is used to attack their edges making removal of the theft deterrent labels time consuming as well as providing noticeable visual evidence of a tampering attempt. The theft deterrent labels serve as seals for merchandise packaging to prevent unauthorized product switching. Furthermore, the theft deterrent labels can be manufactured cost effectively and applied to merchandise packaging easily and safely. A benefit of the theft deterrent labels is that they impede shoplifting attempts by making the process of unauthorized access or removal difficult and time consuming. Consequently, the risk to a shoplifter of getting caught is increased, hence deterring the shoplifter from perpetuating the act of shoplifting.

In the examples above, the theft deterrent labels have been shown in use as being affixed to merchandise packaging in the form of boxes. The theft deterrent labels can of course be used with other packaging (e.g. cartons, parcels, folders, etc.) where it is desired to secure an anti-theft sensor or other structure and seal an opening or seam to the packaging. Depending on the nature of the packaging, the theft deterrent labels may be folded about an edge of the packaging or may simply extend across an opening to the packaging such as a flap, and lie in a horizontal plane. As will be appreciated by those of skill in the art, the theft deterrent labels may be used in virtually any environment where it is desired to protect a sensor, tag or label applied to an article.

Although the theft deterrent labels have been described as overlying anti-theft sensors, tags, labels or other structure, those of skill in the art will appreciate that the anti-theft sensors, tags, labels etc. may be incorporated into the theft deterrent labels. Thus, the theft deterrent labels may be sold stand-alone to overlie existing anti-theft sensors, tags, labels etc. or may be sold as a package with the anti-theft sensors, tags, labels etc.

Although embodiments have been described above and are shown in the accompanying drawings, it will be appreciated by those skilled in the art that variations and modifications may be made without departing from the scope defined by the appended claims, and the scope of the claims should be given the broadest interpretation consistent with the specification as a whole.

1-22. (canceled)

23. A theft deterrent label for affixing to merchandise packaging, comprising:
a flexible, elongate body portion, the flexible, elongate body portion comprising:
a first destructible section to be affixed to a first surface of the merchandise packaging and to overlie an anti-theft sensor thereby to trap the anti-theft sensor between the theft deterrent label and the first surface, the first destructible section having a dimensional footprint larger than a dimensional footprint of the anti-theft sensor;
a second destructible section to be affixed to a second surface of the merchandise packaging, the first destructible section and the second destructible section each having at least one weakness pattern provided therein configured to cause the first and second destructible sections to fracture upon peeling from the merchandise packaging;
a first non-destructible section interposed between and longitudinally separating the first destructible section and the second destructible section and devoid of any weakness pattern, the first non-destructible section to extend over an opening or seam between the first surface and the second surface of the merchandise packaging and being cut resistant;
a third destructible section to one side of the first destructible section and to be affixed to a third surface of the merchandise packaging, the third destructible section having at least one weakness pattern provided therein configured to cause the third destructible section to fracture upon peeling from the merchandise packaging; and
a second non-destructible section interposed between the first destructible section and the third destructible section and being devoid of any weakness pattern, the second non-destructible section to extend over another opening or seam between the first surface and the third surface of the merchandise packaging and being cut resistant.

24. The theft deterrent label of claim 23, wherein each weakness pattern comprises lines of weakness provided in the flexible, elongate body portion.

25. The theft deterrent label of claim 23, wherein the weakness pattern provided in the first destructible section at least partially surrounds an interior region devoid of any weakness pattern, the interior region having a dimensional footprint larger than a dimensional footprint of the anti-theft sensor.

26. In combination, the theft deterrent label of claim 23, the merchandise packaging and the anti-theft sensor, the theft deterrent label positioned adjacent a corner of the merchandise packaging defined by the first surface, the second surface, and the third surface, with the first destructible section affixed to the first surface of the merchandise packaging and trapping the anti-theft sensor between the first destructible section and the first surface, the second destructible section affixed to the second surface of the merchandise packaging with the first non-destructible section extending over the opening or seam between the first surface and the second surface of the merchandise packaging and the third destructible section affixed to the third surface of the merchandise packaging with the second non-destructible section extending over the another opening or seam between the first surface and the third surface of the merchandise packaging.

27. The combination of claim 26, wherein the first destructible section, second destructible section, and third destructible section are fracturable in multiple directions.

28. The combination of claim 26, wherein the first non-destructible section and second non-destructible section are fracture-resistant in all directions.

29. The combination of claim 26, further comprising printed messaging and/or indicia on an upper surface of the flexible, elongate body portion.

30. The combination of claim 29, wherein the printed messaging and/or indicia is at least on the upper surface of the flexible, elongate body portion within the first destructible section.

31. The combination of claim 26, further comprising an alignment feature on the upper surface of the flexible, elongate body portion within the first non-destructible section to facilitate alignment of the non-destructible section with the opening or seam between the first surface and second surface of the merchandise packaging.

32. The combination of claim 26, wherein each weakness pattern comprises lines of perforations, holes and/or cuts provided in the flexible, elongate body portion.
